(19) United States
(12) Patent Application Publication
(10) Pub. No.: US 2006/0102613 A1
(43) Pub. Date: May 18, 2006

(54) Semiconductor fabrication device heater and heating device equipped with the same

(75) Inventors: Akira Kuibira, Osaka-shi (JP); Akira Mikumo, Itami-shi (JP); Masuhiro Natsuhara, Itami-shi (JP); Hirohiko Nakata, Itami-shi (JP)

Correspondence Address: DARBY & DARBY P.C., P. O. BOX 5257, NEW YORK, NY, 10150-5257, US

(73) Assignee: Sumitomo Electric Industries, Ltd., Osaka-shi (JP)

(21) Appl. No.: 11/256,524

(22) Filed: Oct. 20, 2005

(30) Foreign Application Priority Data
Nov. 15, 2004 (JP) 2004-330096

(51) Int. Cl. H05B 3/68

(52) U.S. Cl. 219/444.1; 219/546

(57) ABSTRACT

A heating body and a device equipped with the same provide greater uniformity in temperature distribution between the start of heating and the end of cooling. A semiconductor fabrication device heating body includes a base having a heating surface upon which an object is mounted or positioned at a fixed distance away and is heated, and a resistance heating body. All or part of the base of the heating body has a thermal capacity per unit volume of at least 2.0 J/K·cm³ and a thermal conductivity of at least 50 W/mK.

### BACKGROUND OF THE INVENTION

1. Field of the Invention

The present invention relates to a heater for mounting and heating an object to be heated and a device equipped with the same. More specifically, the present invention relates to a heater and a heating device equipped with the same that is suitable for semiconductor fabrication devices and is used in particular to heat semiconductor wafers.

2. Description of the Background Art

Conventionally, in semiconductor fabrication, a semiconductor substrate (wafer) undergoes various operations such as film formation and etching. Semiconductor fabrication devices that perform these operations on semiconductor substrates use a heater to support and heat a semiconductor substrate.

For example, in a photolithography step, a resist film pattern is formed on the wafer. In this step, after the wafer is washed, dried with heat, and cooled, a resist film is applied to the wafer surface, the wafer is mounted on a heater in the photolithography processing device, and operations such as exposure and development are performed after the wafer is dried. In this photolithography step, the temperature used for drying or baking the resist significantly influences the quality of film application. For this reason, it is important that the temperature of the heater during processing be uniform. Also, in order to improve wafer processing throughput, it is necessary to complete these operations as quickly as possible. Thus, the present inventors looked into semiconductor fabrication devices equipped with cooling means that can cool the heated heater in a short period of time. For example, in Japanese Laid-Open Patent Publication Number 2004-014655, a semiconductor fabrication device was proposed that is equipped with a cooling module that can be abutted against and moved away from a surface of the heater opposite from a wafer mounting surface.

Also, in Japanese Laid-Open Patent Publication Number. 2005-150506, a semiconductor fabrication device was proposed wherein a cooling modules is formed with a flow path for a cooling fluid, thus further improving the cooling rate while maintaining temperature uniformity of the heater from the start of cooling to the end of cooling.

Recent semiconductor fabrication processes for electronic devices and the like demand further uniformity in the temperature distribution of the heater. This, of course, applies to when heating is taking place, but there is also a demand for a higher degree of uniformity in the temperature distribution of the heater during the interval from the start of cooling to the end of cooling. There is also a demand for further improvements in the temperature increase rate and the cooling rate.

With the increased fineness in recent semiconductor wiring, there is a tendency for KrF and ArF to be used as a light source and for chemically amplified film to be used as the resist film during the exposure operation of the photolithography step. In this step, the acid generated during exposure can act as a catalyst so that the resist film can become soluble during the subsequent development step and be washed away. The heat from the PEB (Post Exposure Baking: the curing of resist film after exposure) step for curing the resist film after exposure causes the acid to diffuse, and this displacement is strongly dependent on temperature. As a result, in order to increase pattern precision in photolithography, the resist curing temperature must be carefully controlled. In the pre-exposure PAB (Post Applied Baking: a step for preventing fluidity during exposure by volatilizing a catalyst after the resist film has been coated with a spinner to improve viscosity) step, the dispersion of acid after exposure is influenced by the viscosity of the resist film, thus requiring careful control of the temperature. The reactions in the PEB step and the PAB step also take place when the temperature is being increased, and variations in temperature can significantly affect pattern precision. Thus, temperature variations when the temperature is increasing must be also carefully controlled.

If a single-wafer platform is used to process wafers one by one, increasing the throughput may involve, for example, processing wafers at the rate of one a minute. Generally, when a wafer is heated by being mounted on the heater or by being placed a fixed distance from the heater, the wafer is at room temperature or is slightly pre-heated when it is mounted on the heater. As a result, the temperature of the heater is lowered immediately after mounting. The temperature of the heater is then increased to heat the wafer by applying power to a concentric- or spiral-shaped resistance heating body formed on the heater to generate heat. By keeping the wafer on the heater for an extended period of time after mounting, the heat can be diffused so that the object to be heated can have a uniform temperature. However, this does not provide improved throughput. While controlling uniformity of temperature during the transitional state, e.g., 30 seconds after mounting the object to be heated on the heater, is extremely difficult, increasing throughput requires quickly increasing the temperature and quickly stabilizing temperature variations once a wafer is mounted on and temperature is reduced for the heater used in the PEB step and the PAB step.

While current heaters provide relatively good temperature distribution once the temperature of the heater is in a stable state, during the transitional state when the temperature of the heater is increasing as described above, there is significant temperature variation in the heater. This makes it difficult to form fine circuit patterns effectively using photolithography.

Also, in the PAB step and the PEB step, processing often involves changing the temperature of the heater. For example, after treatment at 180 deg C., the heater temperature may be lowered by 50 deg C. so that treatment at 130 deg C. can take place. In this case as well, increasing throughput requires a heater to achieve uniform temperature as quickly as possible after cooling begins.

The object of the present invention is to provide a heater and a device equipped with the same that allows more uniform temperature distribution from the start of heating to the end of cooling.

### SUMMARY OF THE INVENTION

After extensive research directed at overcoming these problems, the present inventors determined that temperature distribution in the heater can be improved compared with the conventional technology if the material for all or part of the base of the heater has a heat capacity per unit volume of at least 2.0 J/K·cm³ and a thermal conductivity of at least 50 W/mK.

More specifically, in a semiconductor fabrication device heater according to the present invention, is a heater that includes a base formed with a heating surface heating an object to be processed by mounting the object or by heating from a fixed distance and a resistance heating body. All or part of the base of the heater is formed from a material with a heat capacity per unit volume of at least 2.0 J/K·cm³ and a thermal conductivity of at least 50 W/mK.

By setting the heat capacity to be at least 2.0 J/K·cm³, the temperature of the heater tends not to decrease as much when the object to be processed is mounted on the heater, thus minimizing the decrease in thermal uniformity. As a result, when the temperature is restored due to the heat generated by the resistance heating body, the temperature distribution of the heater is reduced and the temperature distribution of the object mounted on the heater can be reduced as well. Furthermore, even if the temperature distribution of the heater increases, the use of a material with a high thermal conductivity of at least 50 W/mK makes it possible to reduce the temperature distribution of the heater by quickly dispersing the heat. More specifically, the temperature distribution during the transitional state can be reduced. The effect is further improved when the heat capacity is at least 3.0 J/K·cm³.

It would be preferable for the base formed with a heating surface heating an object to be processed by mounting the object or by heating from a fixed distance to be formed from a metal or an alloy or a composite body of metal and ceramics. On the back surface thereof is attached a metal or alloy film serving as a resistance heating body.

According to another aspect, the present invention can include: a base formed with a heating surface heating an object to be processed by mounting the object or by heating from a fixed distance; a second base disposed on a back surface of the base; and a resistance heating body. According to another aspect: the base formed with a heating surface heating an object to be processed by mounting the object or by heating from a fixed distance is formed from a metal or an alloy or a composite body of metal and ceramics; the second base disposed on a back surface of the base is formed from a metal or an alloy or a composite body of metal and ceramics; and a metal or alloy foil is interposed between the bases to serve as a resistance heating body.

According to another aspect, the base formed with a heating surface heating an object to be processed by mounting the object or by heating from a fixed distance is formed from a metal or an alloy or a composite body of metal and ceramics; the second base disposed on a back surface of the base is formed from ceramics; and a metal or alloy foil is interposed between the bases to serve as a resistance heating body. According to another aspect, the base formed with a heating surface heating an object to be processed by mounting the object or by heating from a fixed distance is formed from a metal or an alloy or a composite body of metal and ceramics; the second base disposed on a back surface of the base is formed from ceramics; and a circuit serving as a resistance heating body is formed on the ceramics.

It would be preferable for a ratio (a/(a+b)) of a thickness a of the base formed with a heating surface heating an object to be processed by mounting the object or by heating from a fixed distance and a thickness b of the second base disposed on a back surface of the base to be at least 0.05 and no more than 0.95. This is because, when the structure includes the base with the heating surface and the second base disposed on the back surface thereof, unbalanced thickness above and below the resistance heating body can lead to warping and increased flatness, leading to greater temperature distribution in the object being processed. Furthermore, by setting the ratio to be at least 0.05 and no more than 0.49, the resistance heating body can be made closer to the heating surface for the object, thus allowing the heat generated by the resistance heating body to be quickly transferred to the object and improving the temperature distribution in the object, especially during the transitional state.

It would be preferable for a temperature detector of a temperature sensor for detecting a temperature of the base formed with a heating surface heating an object to be processed by mounting the object or by heating from a fixed distance to be disposed between the heating surface and the resistance heating body and is positioned no more than 5 mm from the resistance heating body. The temperature sensor sends a detection signal to a power supply device for the resistance heating body in order to control the temperature by way of the power supply device. By placing the temperature detector of the temperature sensor at the position described above, the temperature of the heat generated by the resistance heating body can be detected before it reaches the heating surface, making it possible to limit the supplied power if the temperature is too high and to increase the supplied power if the temperature is too low. As a result, temperature control is improved.

In particular, when firing resin for a coater/developer, using a temperature higher than the specification can quickly lead to reduced pattern precision, thus imposing a strict temperature overshoot tolerance of 0.1 deg C. In such cases, it would be preferable to make temperature control easier by placing the temperature detector at the position described above.

It would be preferable for an emissivity of the heating surface of the base formed with a heating surface heating an object to be processed by mounting the object or by heating from a fixed distance to be at least 0.5. By setting the emissivity to be at least 0.5, heat is able to be quickly transferred from the heater to the object to be processed, thus improving thermal uniformity of the object, especially during the transitional state. Furthermore, thermal uniformity can be further improved if the emissivity is at least 0.8.

It would be preferable for a flatness of the heating surface of the base formed with a heating surface heating an object to be processed by mounting the object or by heating from a fixed distance to be no more than 0.1 mm. By setting the flatness to be no more than 0.1 mm, the heat transfer from the heater to the object to be processed is made uniform and thermal uniformity is improved, especially during the transitional state. The improvement in thermal uniformity is especially prominent if the flatness is set to no more than 0.05 mm.

It would be preferable for a flatness of the back surface of the heating surface of the base formed with a heating surface heating an object to be processed by mounting the object or by heating from a fixed distance to be no more than 0.1 mm. By setting the flatness to be no more than 0.1 mm, the heat generated by the resistance heating body can be transmitted uniformly to the base with the heating surface, thus providing heating characteristics that are according to design specifications. The advantage is made especially prominent by setting the flatness to be no more than 0.05 mm.

It would be preferable for the flatness of the second base disposed on the back surface to be no more than 0.1 mm. By setting the flatness to be no more than 0.1 mm, when the temperature of the heater decreases due to the mounting of the object on the heating surface, cooling is applied uniformly to the second base disposed at the back surface of the resistance heating body, which serves to prevent temperature reduction through its heat capacity. Since the temperature reduction of the heater is made uniform along a direction parallel with the heating surface, the temperature of the object is made more uniform.

When the heater and the object are flat, the outer perimeters dissipate more heat and tend to become cooler, resulting in a “hot center” state. By providing thermal balance by increasing the temperature of the outer perimeter relative to the inner perimeter, the thermal uniformity of the object can be improved during the transitional state. The thermal uniformity of the heater can be improved by determining the heat dissipation at the outer perimeter and the heat dissipation in the inner perimeter in the device and setting up the design so that the heat generated at the outer perimeter is increased by the difference in heat dissipations. More specifically, it would be preferable for a ratio (c/(c+d)) between a heat generation density c (W/cm²) of a region with a radius ½ that of the heater from a center of the heater and a heat generation density d (W/cm²) of a region outward therefrom to be at least 0.05 and no more than 0.49.

It would be preferable, especially for improving thermal uniformity during the transitional state, for the metal or alloy to be at least one metal or alloy selected from a list consisting of copper (Cu), nickel (Ni), iron (Fe), cobalt (Co), palladium (Pd), and aluminum (Al), which have high heat capacity and thermal conductivity.

It would be preferable, especially for improving thermal uniformity during the transitional state, for the composite body of metal and ceramics to be at least one composite body selected from a list consisting of a composite body of silicon and silicon carbide, a composite body of aluminum and silicon carbide, and a composite body of aluminum and aluminum nitride, which have relatively high heat capacity and thermal conductivity. Heat capacity increases with higher ceramics proportions so it would be preferable for the ceramics proportion to be at least 50%.

It would be preferable for the ceramics to be at least one type of ceramics selected from a list consisting of aluminum nitride (AlN), silicon carbide (SiC), and aluminum oxide (Al₂O₃).

When the emissivity of the heating surface is not high, covering the heating surface with a material with high emissivity can increase emissivity, allowing the object to be quickly heated and improving thermal uniformity during the transitional state. It would be preferable for the cover material to be ceramics since a high emissivity can be easily obtained and the material is heat-resistant.

It would be preferable for the ceramics to be at least one type of ceramics selected from a list consisting of aluminum oxide (Al₂O₃), aluminum nitride (AlN), silicon carbide (SiC), and carbon (C). These materials can easily be applied by thermal spraying, vapor deposition, spraying, printing, and the like, thus allowing the cover to be formed inexpensively. In particular, if aluminum is used for the base of the heating surface, alumetization can be performed to form an aluminum oxide film on the surface.

If the material with the high emissivity is too thin, the advantages obtained from emissivity are reduced, while if the material is too thick, there is thermal stress from the difference in thermal expansion coefficients between the base material and the cover material, leading to splits and peeling especially when there is heat cycling. It would be preferable for the thickness to be in the range of 1-500 microns. It would also be possible to apply abrasion after forming the cover in order to improve the flatness of the heating surface on which the object is mounted or from which the object is kept a fixed distance. For example, in the case of alumite, it the emissivity would be 0.85 at a thickness of 5-7 microns and 0.95 at a thickness of 30 microns. Thus, it would be preferable to set the thickness to 20-200 microns.

Also, if the temperature of the heating body is no more than 400 deg C., the covering material can be a heat-resistant material with a high emissivity. By using a heat-resistant, high-emissivity resin, an improves emissivity is possible with an extremely inexpensive heating surface. Polyimide, fluoroplastic, silicon resin, and epoxy resin are examples of this type of heat-resistant resin that can be used. By using this type of resin, high-emissivity and heat resistance can be easily obtained and the application of the cover is easily performed through thermal spraying, vapor deposition, spraying, printing and baking, and the like, making it possible to apply the cover inexpensively. Also, a tape with a heat-resistant adhesive on one side can be adhesed to the surface of the resin on which the object is mounted to allow easy formation of an inexpensive high-emissivity surface. If the thickness is insufficient, the emissivity will be insufficient, while if the layer is too thick, thermal resistance results, thus reducing thermal uniformity during the transitional state. As a result, it would be preferable for the thickness to be 1-500 microns.

By forming the resistance heating body from a metal or alloy foil, mass production is made easier through etching or punching of the foil. When the resistance heating body is interposed between metal and metal or metal and ceramics, the contact between metal and the resistance heating body can lead to an electrical short-circuit, requiring an insulative foil or insulative resin or the like between the metal and the resistance heating body. It would be preferable to use polyimide, fluoroplastic, silicon resin, epoxy resin, mica, or the like as the insulation due to the high heat resistance and inexpensiveness of these materials.

Since the thermal conductivity of insulative sheets is generally lower than the thermal conductivity of metal and thermally conductive ceramics, it would be preferable to make the sheets as thin as possible, but insulation will be inadequate and breakage may take place if the sheets are too thin. Thus, it would be preferable for the thickness of insulative foil or insulative resin to be approximately 1-500 microns. For a suitable balance between emissivity efficiency and heat resistance, it would be preferable to have the thickness of the insulative foil or insulative resin set to 20-200 microns.

Also, if there are variations in the thickness of the insulative foil or the insulative resin, there can be breaks in the insulation due to localized electrical field concentrations. Thus, it would be preferable to keep the variations in thickness to within 20%.

When insulation is provided by interposing an insulative sheet between metal and the resistance heating body, a cylindrical or foil electrode for supplying power to the resistance heating body may pass through holes formed on the metal. In such cases, insulation will not be possible if e<=f where e is the hole diameter in the metal and f is the hole diameter in the insulative sheet. Cases where e=f are also dangerous due to settings tolerances, so it is necessary to ensure that f<=e−0.1 (mm). Alternatively, spot facing with a depth of at least 0.1 mm must be performed on the metal plate or beveling of at least 0.1 mm must be performed at the edges of the hole in the metal in order to prevent the resistance heating body from coming into contact with the metal plate.

Also, it would be preferable to have the resistance heating body formed as a metal circuit on the ceramics. This allows fine circuitry to be formed accurately through printing or vapor deposition. Insulation can be easily provided by covering the resistance heating body with ceramics (e.g., AlN, Al₂O₃, SiC) or glass.

In terms of heat resistance, it would be preferable for the resistance heating body to be formed from at least one selected from a list consisting of tungsten (W), molybdenum (Mo), nickel (Ni), chrome (Cr), silver (Ag), palladium (Pd), platinum (Pt), and stainless steel (SUS). If two or more of the above are selected, it would be preferable to select Ag—Pd, Ni—Cr, or the like. In terms of heat resistance and thermal conductivity, it would be preferable for the ceramics to be aluminum nitride (AlN), silicon carbide (SiC), or aluminum nitride (Al₂O₃).

When changing the temperature of the heating body when applying heat, the use of a cooling module to quickly reduce temperature and control thermal uniformity in the transitional state is preferable. It would be preferable for the cooling module to be installed so that it is movable rather than being continuously engaged so that it can be abutted against the heating module when cooling is needed so that quick cooling can be achieved.

With a semiconductor fabrication device in which the semiconductor fabrication device heater described above is placed in a metal container, the influence of environmental variations is reduced.

According to the present invention, the material for all or part of the heater has a heat capacity per unit volume of at least 2.0 J/K·cm³ and a thermal conductivity of at least 50 W/mK. This makes it possible to provide greater uniformity in the temperature distribution of the heater and, in particular, greater uniformity in temperature uniformity during the transitional period. Also, uniform temperature distribution can also be achieved in the regular state. With a semiconductor fabrication/inspection device or flat display panel fabrication/inspection device or a photo resistance heating device equipped with this type of heater, the temperature distribution of the heater is more uniform that that of conventional devices. Thus, it is possible to provide improved yield, reliability, integration, image quality, and performance for semiconductors and flat display panels.

### BRIEF DESCRIPTION OF THE DRAWINGS

FIG. 1 is a simplified cross-section drawing showing an example of a heating body according to the present invention.

FIG. 2 is a simplified cross-section drawing showing another example of a heating body according to the present invention.

FIG. 3 is a simplified cross-section drawing showing another example of a heating body according to the present invention.

### DETAILED DESCRIPTION OF THE INVENTION

A semiconductor fabrication device heater according to the present invention is a heater formed from: a resistance heating body; and a base with a heating surface for heating an object to be heated either by having the object mounted or positioned at a fixed distance. Part or all of the base of the heater is formed from a material having a heat capacity per unit area of at least 2.0 J/K·cm³ and a thermal conductivity of at least 50 W/mK.

The heat capacity of the base of the heater affects the drop in temperature of the heater when the wafer is mounted. More specifically, if the base has a high heat capacity, the influence of the heat taken away by the wafer is limited and the temperature setting recovers quickly. Also, since the base after the wafer is mounted has heat taken away by the mounted wafer, there is a drop in temperature as described above, but the extent of the drop varies depending on the location on the base. Under the most simple conditions, the section of the base corresponding to the center of the wafer has the most heat taken away and therefore has a large drop in temperature. Meanwhile, the sections of the base that do not face the wafer experience minimal change in heat so that the temperature drop is limited. In this manner, the temperature distribution is affected by the various temperature drops resulting from the influence of the mounted wafer and the sizes of the base and wafer and the positioning and the like. In order to quickly make the wafer temperature distribution uniform, the temperature distribution of the base must be in a suitable state. Thus, the uneven temperature distribution of the base is a significant obstacle to providing a uniform wafer temperature.

In order to prevent this type of temperature distribution in the base, the drop in temperature of the base when the wafer is mounted must be restricted and a suitable temperature distribution after this temperature drop must be provided. In order to form a temperature distribution that is suited for uniform wafer temperature, the necessary heat, taking the heat taken away by the wafer into account, must be supplied in the shortest amount of time possible. Furthermore, as described above, the heat taken away by the wafer is not uniform throughout the base. In order to meet these conditions, it was found that the temperature drop in the base could be restricted by using a material with a high heat capacity and a high heat conductivity in the base. A heat capacity of at least 2.0 J/K·cm³ is preferable since it restricts the temperature drop in the heater when the wafer is mounted, thus improving thermal uniformity during the transitional state. Also, with a thermal conductivity of 50 W/mK, even if thermal uniformity is reduced, rapid heat dispersion makes thermal uniformity possible, thus improving thermal uniformity in the transitional state.

It would be preferable for the material of the base in the heater to be formed from a metal or an alloy or a composite material formed from metal and ceramic. For example, Al has a heat capacity of 2.4 J/K·cm³ and a thermal conductivity of 236 W/mK, thus making it possible to improve thermal uniformity during the transitional state. Al is a preferable material because alumetization can be performed on the surface to easily provide insulation and improve emissivity.

It would be more preferable for the heat capacity per unit volume to be at least 3.0 J/K·cm³. This restricts significant temperature drops in the base and provides improved advantages. Examples of materials with heat capacity per unit volume of at least 3.0 J/K·cm³ and thermal expansion rate of at least 50 W/mK are Cu, Ni, Fe, Co, and Pd. Cu is a very preferable material with a heat capacity of 3.4 J/K·cm³ and thermal conductivity of 403 W/m·K. Also, Ni has a heat capacity of 3.9 J/K·cm³ and a thermal conductivity of 94 W/m·K, Fe has a heat capacity of 3.4 J/K·cm³ and a thermal conductivity of 84 W/m·K, Co has a heat capacity of 3.8 J/K·cm³ and a thermal conductivity of 69 W/m·K, Pd has a heat capacity of 3.0 J/K cm³ and a thermal conductivity of 72 W/m·K. All of these are preferable materials.

An example of a composite material formed from metal and ceramics is a silicon-silicon carbide (Si—SiC). When the SiC proportion is 30%, the heat capacity is 2.28 J/K·cm³ and the thermal conductivity is 150 W/m·K. If the SiC proportion is 70%, the heat capacity is 3.00 J/K·cm³ and the thermal conductivity is 172 W/m·K. Higher SiC proportions are preferable in terms of both heat capacity and thermal conductivity. Another example is the aluminum-silicon carbide composite material (Al—SiC). If the SiC proportion is 30%, the heat capacity is 2.3 J/K·cm³ and the thermal conductivity is 150 W/m·K, thus making the material preferable. Furthermore, another preferable material is an aluminum-aluminum nitride composite body (Al—AlN). With an AlN proportion of 70%, the heat capacity is 2.75 J/K·cm³ and the thermal conductivity is 176 W/m·K, thus making the heat capacity at least 2.0 J/K·cm³ and the thermal conductivity at least 50 W/m·K.

By having an emissivity of at least 0.5 for the heating surface of the base, it is possible to transfer the heat quickly from the heater to the heated body, thus making it possible to thermal uniformity of the heated body especially during the transitional state. Emissivity generally tends to be low in metals and high in ceramics and resin. Metals, alloys, and metal-ceramic composite bodies are preferable because they are inexpensive and, unlike ceramics, where a sintered body is obtained by undergoing non-uniform sintering, production from a uniform system is possible. As a result, although there are no special restrictions on the material for the heater of the present invention, it would be preferable in terms of heat resistance and cost to use a metal or an alloy or a metal-ceramic composite material. Using resin as the material for the heater is not preferable because of its heat resistance and rigidity properties.

Thus, by using a high-emissivity material to cover the surface of the metal or alloy or metal-ceramic composite body with high thermal conductivity it is possible to obtain a high-emissivity heater that has a high heat capacity and high thermal conductivity.

It would be preferable for the cover material to be a ceramic or heat-resistant resin with high emissivity. With ceramics, the cover can be applied through thermal spraying or vapor deposition of ceramic powder such as C, SiC, Al₂O₃, SiC, or AlN. If the cover is too thin, there is reduced advantage in providing high emissivity. If the cover is too thick, the ceramic cover can split or peel away due to thermal stress caused by thermal expansion differences between the metal and ceramic. As a result, it would be preferable for the thickness to be in the range of 1-500 microns. Furthermore, in terms of cost and ease of forming the cover, a range of 1.5-200 microns is preferable. Variations in thickness can create variations in emitted heat, hindering the restriction of thermal uniformity. Thus, it would be preferable for the thickness variation to be no more than 20%.

It would be preferable before applying the ceramic cover to apply one or more than one base layers to serve as a thermal stress relaxing layer that relaxes thermal stress by improving adhesion between the ceramic cover and the metal or alloy or metal-ceramic composite body. For example, thermal stress is relaxed and adhesion strength is improved when an Al₂O₃ cover is applied after application of TiC or TiN.

Although thermal spraying allows inexpensive formation of film thicknesses of 200-500 microns, the surface flatness may become too high. Flatness can be obtained by abrading after thermal spraying. If there is too much surface roughness, there will be variations in emissivity. If the surface approaches a mirror surface reflectivity becomes high and emissivity is reduced. As a result, it would be preferable for the surface roughness to have an Ra of at least 0.05 microns and no more than 20 microns. A surface roughness with an Ra of at least 0.1 microns and no more than 5 microns allows easy production and is preferable in terms of cost.

Since vapor deposition involves batch processing, the advantages from mass production cannot be obtained and costs are increased. However, uniform film with high adhesion can be obtained.

It would also be possible to cover the surface of the metal or alloy or metal-ceramic composite body with a heat-resistant resin cover. Polyimide provides high heat resistance and insulation and can be used with no problems at temperatures of no more than 300 deg C. It would be possible to adhese a polyimide sheet with a heat-resistant adhesive material attached to one side. Alternatively, a polyimide paste can be printed or applied with a spinner or the like and baked. Instead of polyimide, it would also be possible to use resins with high heat resistance and high emissivity such as fluorine resin, silicon resin, epoxy resin, or the like.

Since the metal or alloy or metal-ceramic composite body is conductive, adequate insulation must be provided between these materials and the resistance heating body. For example, it would be preferable to provide a cover with a polyimide resin sheet or mica sheet or resin or ceramics. Since the thermal conductivity of polyimide is 0.5 W/mK and the thermal conductivity of mica sheets is 0.7 W/mK, both of these have thermal conductivities that are lower than those of the metal or alloy metal-ceramic composite body, and thus can become factors in thermal resistance, so it would be preferable to make them as thin as possible, but if they are too thin they do not provide adequate insulation or they may tend to break and result in reduced reliability. As a result, a thickness of approximately, 1-500 microns is preferable. In particular, a thickness of 20-200 microns is more preferable for providing adequate insulation and breakage resistance while keeping thermal resistance acceptable. Also, it would be preferable to use a material that has a thickness variation of no more than ±10%. If the thickness exceeds ±10%, the voltage applied to both sides of the insulation sheet can concentrate at thin sections of the insulation sheet, leading to a tendency toward insulation breakage.

If the heating surface has too much flatness, the contact or proximity with the wafer may vary depending on location, which can lower thermal uniformity during the transition state. Therefore, a flatness of no more than 0.1 mm is preferable. In particular, a flatness of no more than 0.5 mm is preferable to provide a uniform contact or distance between the wafer and the heating surface.

While a certain degree of roughness on metal surfaces improves adhesion through anchoring when ceramics or resin is applied, too much roughness on metal surfaces is not preferable since it can lead to variations in contact or the space between the wafer and the heating surface, leading to less thermal uniformity during the transition state.

For the surface roughness, an Ra of 0.005-5 microns is preferable, and 0.01-1.0 microns is especially preferable to provide suitable thermal uniformity while also providing suitable adhesion.

Ceramics are superior in that they can be printed and burned directly onto metal circuits or vapor deposition, sputtering, or the like can be performed with masking without leading to problems in the insulation between resistance heating bodies and providing high-precision circuit formation. As a result, it would also be preferable to place a ceramics heater wherein a resistance heating body is formed on ceramics on the back side of the heating surface, and to use a hybrid heater on the heating surface side formed from a metal or a metal alloy or a metal-ceramics composite body having a high heat capacity and a high thermal conductivity.

For ceramic materials, various types of ceramics can be used. In particular, it would be preferable to use ceramics with minimal defects such as pores in order to limit the generation of particles. In particular, a porosity of no more than 1% would be preferable to limit particle generation. If the porosity exceeds 1%, friction between the edges of pores on the surface and the mounted objects such as a wafer can lead to dropped particles at the edges of pores on the ceramics. As long as the porosity is no more than 1%, the material used can be selected based on the application. Also, if the uniformity of the temperature distribution on the mounting surface of the heater is to be emphasized, it would be preferable to use aluminum nitride or silicon carbide, which have high thermal conductivity. If reliability, e.g., mechanical strength, is to be emphasized, silicon nitride would be preferable due to its strength and resistance to thermal shock. Also, if cost is to be emphasized, aluminum oxide would be preferable.

Of these ceramics, aluminum nitride (AlN) provides a suitable balance between performance and cost. In the description below, a method for making a heater according to the present invention using AlN will be presented.

It would be preferable for the specific surface area of the AlN raw powder to be 2.0-5.0 m²/g. If the specific surface area is less than 2.0 m²/g, the relatively large size of the aluminum nitride particles reduces sintering performance. This would prevent sintering unless the sintering temperature exceeds 2000 deg C. For example, if a furnace that uses carbon serves as the sintering furnace, the carbon vapor pressure would increase and the rate of carbon deterioration would increase, making the arrangement not preferable.

Also, if the specific surface area exceeds 5.0 m²/g, agglomeration of the powder becomes very prominent, making it difficult to handle. More specifically, when the specific surface area increases, there is more powder agglomeration. This leads to inferior mixing with the sintering additive, which requires a higher sintering temperature, leading to the problem described above. Also, if the powder has a high specific surface area, the oxygen on the surface of the AlN powder increases, reducing the thermal conductivity of the sintered body.

Furthermore, it would be preferable for the raw powder to have an oxygen content of no more than 2 wt %. If the oxygen content exceeds 2 wt %, the thermal conductivity of the sintered body is reduced. Also, it would be preferable for the metal impurities content other than aluminum contained in the raw powder to be no more than 2000 ppm. If the metal impurities content exceeds this range, the thermal conductivity of the sintered body is reduced. More specifically, group-IV elements such as Si and ferrous elements such as Fe especially act to reduce thermal conductivity of the sintered body. Thus, it would be preferable for the content of these to be no more than 500 ppm each.

Since AlN is a material that is difficult to sinter, it would be preferable to add a sintering additive to the raw AlN powder. It would be preferable for the sintering additive that is added to be a rare-earth element compound. Rare-earth element compounds react during sintering with aluminum oxide or aluminum oxynitride present on the surfaces of the aluminum nitride powder particles, promoting the densification of the aluminum nitride and also removing oxygen, which is a factor in reduced thermal conductivity of the aluminum nitride sintered body. Thus, the thermal conductivity of the aluminum nitride sintered body can be improved.

In particular, for the rare-earth element compound, a yttrium compound is preferable because it is especially effective in removing oxygen. It would be preferable for the amount added to be 0.01-5 wt %. If the amount is less than 0.01 wt %, obtaining a dense sintered body is difficult and the thermal conductivity of the sintered body is reduced. Also, if the amount exceeds 5 wt %, sintering additive will be present at the grain boundaries of the aluminum nitride sintered body, leading to dropped particles when the sintered body is used in a corrosive atmosphere and the sintering additives at the particle boundaries are etched. Furthermore, it would be preferable for the amount of the sintering additive to be added to be no more than 1 wt %. If the amount is no more than 1 wt %, the presence of sintering additive at the triple point of grain boundaries is significantly reduced, thus improving corrosion resistance.

Also, for the rare-earth element compound, it would be possible to use oxides, nitrides, fluorides, stearate compounds, and the like. Of these, oxides are preferable because they are inexpensive and easy to obtain. Also, stearate compounds have a high affinity with organic solvents so that they mix well when raw aluminum nitride powder and sintering additive and the like are mixed with organic solvent.

Next, a predetermined amount of solvent, binder, and, if necessary, dispersant and deflocculent, are added to the raw aluminum nitride powder and sintering additive, and the results are mixed. Mixing can be performed with a ball mill or ultrasound or the like. With this type of mixing, a raw slurry is obtained.

The resulting slurry is shaped and sintered to form an aluminum nitride sintered body. This can be performed using co-firing or post-metalizing.

First, post-metalizing will be described. A spray dryer or the like is used on the slurry to form granules. The granules are inserted into a predetermined die, and pressed. It would be preferable for the press pressure to be at least 9.8 MPa. If the pressure is less than 9.8 MPa, the strength of the shaped body will often be inadequate, making it easy for breakage or the like to take place during handling.

The density of the shaped body varies depending on the amount of sintering additive added and binder content, but it would be preferable for the density to be at least 1.5 g/cm³. If the density is less than 1.5 g/cm³, the distance between the raw powder particles becomes relatively large, hindering sintering. Also, it would be preferable for the density of the shaped body to be no more than 2.5 g/cm³. If the density exceeds 2.5 g/cm³, adequate removal of the binder in the shaped body during the subsequent degreasing step becomes difficult. This results in a relatively high carbon content in the degreased body, and this carbon hinders the sintering of AlN, making it difficult to obtain a dense sintered body.

Next, the shaped body is heated in a non-oxidizing atmosphere and degreasing is performed. If degreasing is performed in an oxidizing atmosphere such as in the open air, the AlN powder surfaces become oxidized, leading to reduced thermal conductivity in the sintered body. Nitrogen and argon are preferable as non-oxidizing atmosphere gases. It would be preferable for the heating temperature in the degreasing operation to be at least 500 deg C. and no more than 1000 deg C. At a temperature of less than 500 deg C., the binder cannot be adequately removed, leading to excessive residual carbon in the shaped body after degreasing so that subsequent sintering is hindered. Also, if the temperature exceeds 1000 deg C., the residual carbon content becomes too low, reducing the ability to remove the oxygen of the oxide film present on the AlN powder surfaces, resulting in reduced thermal conductivity in the sintered body.

Also, it would be preferable for the amount of residual carbon in the shaped body after degreasing to be at no more than 1.0 wt %. If the residual carbon exceeds 1.0 wt %, sintering is hindered, preventing a dense sintered body from being obtained.

Next, sintering is performed. Sintering is performed in a non-oxidizing atmosphere such as nitrogen or argon at 1700-2000 deg C. In this step, it would be preferable for the moisture in the atmosphere gas such as nitrogen to be no more than −30 deg C. dew point. If the moisture content exceeds this, AlN reacts with the atmosphere gas during sintering to form oxynitrides, which can lead to reduced thermal conductivity. Also, it would be preferable for the oxygen content in the atmosphere gas to be no more than 0.001 vol %. If the oxygen content is high, the AlN surface oxidizes, which can lead to reduced thermal conductivity.

Furthermore, it would be preferable for the tool used in sintering to be a shaped body formed from boron nitride (BN). A BN shaped body has adequate heat resistance for the sintering temperature, and the surface thereof has solid lubrication properties, which reduces the friction between the tool and the shaped body when the shaped body is compressed during sintering. This makes it possible to obtain a sintered body with minimum distortion, i.e., deformation.

The obtained sintered body is processed as needed. If a conductive paste is to be screen-printed in the next step, it would be preferable for the surface roughness of the sintered body to have an Ra of no more than 5 microns. If the roughness exceeds 5 microns, defects such as pattern smears and pinhole formation tends to take place when the circuit is screen-printed. It would be more preferable for the surface roughness to have an Ra of no more than 1 micron.

When applying abrasion to achieve this surface roughness, it would be preferable to apply abrasion to both sides of the sintered body when screen-printing is to be performed on both sides, but it would also be preferable even when screen-printing is to be performed only on one side to abrade the side opposite from the surface to be screen-printed. If only the screen-printed surface is abraded, the sintered body will be supported by a surface that has not been abraded during screen-printing. Since the surface that has not been abraded can be formed with projections and contaminants, the sintered body can be unstable, thus preventing proper screen-printing of the circuit pattern.

Also, it would be preferable for the degree of parallelism of the two surface to be no more than 0.5 mm. If the degree of parallelism exceeds 0.5 mm, there may be variations in the thickness of the conductive paste during screen-printing. It would be especially preferable for the degree of parallelism to be no more than 0.1 mm. Furthermore, it would be preferable for the flatness of the surface to be screen-printed to be no more than 0.5 mm. If the flatness exceeds 0.5 mm, there may be variations in the thickness of the conductive paste. It would be especially preferable for the flatness to be no more than 0.1 mm.

The electrical circuit is formed by screen-printing conductive paste on the abraded sintered body. The conductive paste can be obtained by mixing a metal powder, an oxide powder when necessary, a binder, and a solvent. In order to match thermal expansion coefficients with ceramics, it would be preferable for the metal powder to be tungsten, molybdenum, or tantalum. It would also be possible to use mixtures or alloys of silver, palladium, platinum, and the like.

Also, in order to increase the adhesion with AlN, an oxide powder can be added. It would be preferable for the oxide powder to be an oxide of a group IIa element or group IIIa element or Al₂O₃ or SiO₂ or the like. More specifically, yttrium oxide is preferable because it has extremely good wettability with regard to AlN. It would be preferable for the amount of oxide added to be 0.1-30 wt %. If the amount is less than 0.1 wt %, the adhesion strength between AlN and the metal layer, i.e., the formed electrical circuit, is reduced. Also, if the amount exceeds 30 wt %, the electrical resistance of the metal layer, i.e., the electrical circuit increases.

Next, these powders are adequately mixed and binder and solvent are added to form conductive paste.

This is used to screen-print the circuit pattern. It would be preferable for the thickness of the conductive paste after drying to be at least 5 microns and no more than 100 microns. If the thickness is less than 5 microns, the electrical resistance becomes too high and the adhesion strength decreases as well. Also, the adhesion strength decreases when the thickness exceeds 100 microns as well.

Also, it would be preferable for the pattern pitch formed for the resistance heating body to be at least 0.1 mm. With a pitch of less than 0.1 mm, when current flows through the resistance heating body, current leakage may take place depending on the temperature and the applied voltage, leading to a short circuit. More specifically, if the structure is to be used in a temperature of at least 500 deg C., it would be preferable for the pattern pitch to be at least 1 mm and more preferably at least 3 mm. Also, in addition to the resistance heating body pattern, it would be possible to screen-print RF electrodes and electrodes for an electrostatic chuck.

Next, after degreasing the conductive paste, firing is performed. The degreasing is performed in a non-oxidizing atmosphere such as nitrogen or argon. It would be preferable for the degreasing temperature to be at least 500 deg C. At a temperature of less than 500 deg C., the elimination of the binder in the conductive paste is inadequate and carbon residue is left behind in the metal layer. This leads to carbides of the metal being formed during firing.

It would be preferable for firing to be performed in a non-oxidizing atmosphere such as nitrogen or argon at a temperature of at least 1500 deg C. If the temperature is less than 1500 deg C., there is inadequate grain growth of the metal particles in the conductive paste, resulting in a very high electrical resistance in the metal layer after firing. Also, it would be preferable for the firing temperature to not exceed the sintering temperature for the ceramics. If the conductive paste is fired at a temperature that exceeds the sintering temperature for the ceramics, the sintering additive and the like contained in the ceramics can begin to volatilize, while the particle growth of the metal particles in the conductive paste is accelerated, resulting in reduced adhesion strength between the ceramics and the metal layer.

Next, an insulative coat can be formed on the metal layer in order to keep the metal layer insulated. It would be preferable for the insulative coat to be formed from the same material used in the ceramics on which the metal layer is formed. If the ceramics and the insulative coat film have significantly different compositions, this leads to different thermal expansion coefficients. This can lead to undesirable results such as warping after firing. For example, using aluminum nitride, a predetermined amount of a group IIa or group IIIa oxide or a carbonate can be added and mixed as a sintering additive to the aluminum nitride, the binder and solvent can be added to this to form a paste, and this paste can be screen-printed onto the metal layer. It would be preferable for the sintering additive used here to be at least 0.01 wt %. If the amount is less than 0.01 wt %, the ceramics does not densify, and the function of maintaining insulation between heating body patterns is reduced. Also, the amount of sintering additive added must not exceed 20 wt %. If this range is exceeded, the excess sintering additive can permeate into the metal layer and change the resistance of the resistance heating body.

There are no special restrictions on the thickness of the film to be applied but it would be preferable for the thickness to be at least 5 microns. A thickness less than this is not preferable because of the difficulty in obtaining adequate insulative properties.

If a metal with a high melting point such as W is used for the metal layer, the insulation layer can be formed by applying and then firing or curing glass ceramics, glazed glass, organic resin, or the like. Types of glass that can be used include borosilicate glass, lead oxide, zinc oxide, aluminum oxide, or silicon oxide. An organic solvent and binder are added to the powder to form a paste, which is then screen-printed. There are no special restrictions on the application thickness but a thickness of at least 5 microns is preferable here as well. This is because with a thickness of less than 5 microns, adequate insulation is difficult to obtain. There are no special restrictions for the firing temperature, but it would be preferable to use an inert gas atmosphere such as nitrogen or argon since the metal layer does not have oxidation resistance.

It would also be possible to use a mixture or alloy of silver, palladium, platinum, or the like as the conductive paste. Since the volume resistivity of the conductor increases according to the amount of palladium or platinum relative to the silver content, the amount of these metals that are added can be adjusted according to the circuit pattern. Also, since these additives serve to prevent migration between circuit patterns, it would be preferable to add at least 0.1 parts by weight for 100 parts by weight of silver.

It would be preferable to add metal oxide to the metal powder in order to maintain adhesion with AlN. For example, it would be possible to add aluminum oxide, silicon oxide, copper oxide, boron oxide, zinc oxide, lead oxide, rare-earth element oxides, transitional metal element oxides, alkaline earth metal oxides, or the like. It would be preferable for the amount added to be at least 0.1 wt % and no more than 50 wt %. A content less than this is undesirable due to reduced adhesion with the aluminum nitride. Also, a greater content is not desirable because of the hindrance to sintering of metal components, e.g., silver.

These metal powders and inorganic powders are mixed and an organic solvent and binder are added to form a paste, which can then be screen-printed to form a circuit. The formed circuit pattern is fired in an inert gas atmosphere such as nitrogen or in the open air at a temperature from 700 deg C. to 1000 deg C.

In order to maintain insulation between circuits, glass ceramics, glazed glass, organic resin, or the like can be applied and fired or cured in order to form an insulation layer. Types of glass that can be used include borosilicate glass, lead oxide, zinc oxide, aluminum oxide, silicon oxide, and the like. An organic solvent and a binder is added to these powders to form a paste, which is then screen-printed. There are no special restrictions on the application thickness, but it would be preferable for the thickness to be at least 5 microns here as well. With a thickness of less than 5 microns, it is difficult to obtain adequate insulation.

Also, it would be preferable for the firing temperature to be lower than the temperature used to form the circuit as described above. If firing takes place at a temperature used in circuit firing, the resistance of the circuit pattern can vary significantly.

Next, a ceramic sintered body can be layered over this as needed. The layering should take place by way of a bonding agent. The bonding agent is formed by adding a group IIa element compound or group IIIa element compound and a binder and solvent to an aluminum oxide powder or an aluminum nitride powder and forming a paste, which is then applied to the bonding surface using screen-printing or the like. There are no special restrictions on the thickness of the bonding agent, but it would be preferable for the thickness to be at least 5 microns. A thickness of less than 5 microns tends to result in bonding defects such as inconsistent bonding and pinholes in the bonding layer. The metal layer may react with the bonding layer, so it would be preferable to form a protective layer having aluminum nitride as its main component on the metal layer as described above.

The ceramic sintered body on which the bonding agent is applied is degreased in a non-oxidizing atmosphere at a temperature of at least 500 deg C. Then, the ceramic sintered body to be layered over this is applied, a predetermined load is applied, and heat is applied in a non-oxidizing atmosphere to bond the ceramic sintered bodies. It would be preferable for the load to be at least 5 kPa. A load of less than 5 kPa tends to result in inadequate bonding strength or the bonding defects described above.

There are no special restrictions on the heating temperature for bonding as long as the temperature provides an adequate adhesion of the ceramic sintered bodies by way of the bonding layer. However, it would be preferable for the temperature to be at least 1500 deg C. With a temperature of less than 1500 deg C., it is difficult to obtain adequate bonding strength and bonding defects tend to occur. For the non-oxidizing atmosphere during degreasing and bonding described above, it would be preferable to use nitrogen or argon or the like.

A ceramic layered sintered body that serves as a substrate of a heating body is obtained from the procedure described above. Instead of using conductive paste, it would also be possible to form the electrical circuit using molybdenum wires (coils), e.g., for heater circuits, or a molybdenum or tungsten mesh, e.g., for electrostatic chuck electrodes, RF electrodes, and the like.

In this case, the molybdenum coil or mesh is placed in the raw AlN powder and hot-pressing is performed. The hot-pressing temperature and atmosphere can be the same as the sintering temperature and atmosphere used for AlN described above, but it would be preferable for the hot-press pressure to be at least 0.98 MPa. With a pressure of less than 0.98 MPa, gaps can form between the AlN and the molybdenum coil or mesh, reducing heater performance.

Next, a co-firing method will be described. The raw slurry described above is shaped into sheets using the doctor blade method. There are no special restrictions regarding the forming of the sheets, but it would be preferable for the thickness of the sheets to be no more than 3 mm after drying. If the sheet thickness exceeds 3 mm, there is greater drying shrinkage of the slurry, which increases the possibility of fissures in the sheet.

A metal layer that will form an electrical circuit having a predetermined shape on the sheet is formed by applying the conductive paste using screen-printing or the like. The conductive paste can be the same as that used in the description for the post-metalizing method. However, in the co-firing method, adding oxide particles to the conductive paste is acceptable.

Next, a sheet on which the circuit is formed is stacked with a sheet on which a circuit is not formed. The sheets are stacked by setting up each sheet to predetermined positions and stacking. A solvent can be applied between the sheets as needed. Heating is performed as needed in the stacked state. If heating is to be performed, it would be preferable for the heating temperature to be at least 150 deg C. If heating is performed at a higher temperature, the stacked sheets will be significantly deformed. Then, pressure is applied to the stacked sheets to integrate the sheets.

It would be preferable for the applied pressure to be in the range of 1-100 MPa. With a pressure of less than 1 MPa, the sheets are not adequately integrated, which can lead to peeling during later steps. Also, if the pressure exceeds 100 MPa, too much sheet deformation can take place.

This layered structure is degreased as in the post-metalizing method described above. The degreasing operation, the sintering temperature, the amount of carbon, and the like are the same as those of the post-metalizing method. When printing the conductive paste to the sheet, the conductive heater can be easily formed by printing electrostatic chuck electrodes and heater circuits on multiple sheets and stacking these sheets. In this manner, a ceramic layered sintered body used to form a heater substrate of a heating body can be obtained.

If the electrical circuit for the heater circuit is formed on the outermost layer of the ceramic layered body, an insulative coat can be formed on the electrical circuit as in the post-metalizing method described above in order to maintain insulation and to protect the electrical circuit.

In the present invention, transitional thermal uniformity can be improved by changing the heat generation density of the resistance heater pattern according to the heat dissipation state of the heating body. While multiple zones can be set up with each zone being controlled separately, it would be preferable whenever possible to use only one zone for control in order to reduce control system costs and to simplify control operations. More heat can escape from the outer perimeter or the support section for the heater body, and heating circuits cannot be formed around the hole for the object lift pin, resulting in lower temperature. It would be preferable to capture usage environment conditions and to use a computer simulation to design heat density in order to improve transitional thermal uniformity.

The present invention can also be equipped with a cooling module. When the heater substrate of the heating body needs to be cooled, the cooling module can be abutted against the substrate of the heating body or the resistance heating body to absorb heat and rapidly cool the heating body. This significantly improves the cooling rate of the heating body and increases throughput. There are no special restrictions on the materials used for the cooling module, but it would be preferable to use aluminum, copper, and alloys thereof due to their relatively high thermal conductivity. Also, stainless steel, magnesium alloy, nickel, and other metals can be used. Also, an oxidation-resistant metal film formed from Ni, gold, silver, or the like can be formed on the cooling module through plating, thermal spraying, or the like in order to provide oxidation resistance.

It would also be possible to use ceramics as a material for the cooling module. There are no special restrictions for this, but it would be preferable to use aluminum nitride or silicon carbide because their relatively high thermal conductivity makes it possible to quickly absorb heat from the heating body. Also, silicon nitride and aluminum oxynitride are preferable because their high mechanical strength provides longevity. Also, oxide ceramics such as alumina, cordierite, and steatite are preferable because they are relatively inexpensive. Since different types of materials can be used for the cooling module as described above, the material can be selected according to the application. Of these, aluminum with nickel plating is especially preferable because of its superior oxidation resistance, high thermal conductivity, light weight, and relative inexpensiveness.

It would also be possible to have a cooling medium flow through the cooling module. This makes it possible to quickly remove from the cooling module heat that has been transferred from the heating body to the cooling module, thus further improving the cooling rate of the heating body. While there are no special restrictions on the cooling medium used for the cooling module, water or fluorinert are especially preferable because of their high specific heat and inexpensiveness. In one preferable example, two aluminum plates are prepared and a flow path is formed through machining or the like on one of the aluminum plates in order to allow water to flow. Nickel plating is applied to the front surface in order to improve corrosion resistance and oxidation resistance. Then, the other nickel-plated aluminum plate is attached. An O-ring or the like is inserted at the perimeter of the flow path in order to prevent water from leaking, and the two aluminum plates are attached with screws or by welding.

The flatness of the contact surface of the substrate of the heating body with the cooling module and the flatness of the contact surface of the cooling module with the substrate are set up to have a sum of no more than 0.8 mm. It would be especially preferable for the sum of the flatness values to be no more than 0.4 mm. Conventionally, there have been proposals to make temperature distribution of an object to be heated uniform by improving the flatness and the surface roughness of the main surface of the heating body upon which the object to be heated is mounted. However, there have been no proposals for making the temperature distribution uniform and improving the cooling rate and heater units equipped with a cooling module by improving the flatness of the contact surfaces of the heating body and the cooling module.

By improving the flatness of the contact surfaces of the surface of the substrate forming the heating body that abuts the cooling module as well as the flatness of the surface of the cooling module that abuts the substrate, the substrate of the heating body can come into uniform contact with the cooling module, thus improving the adhesion between the two and improving thermal conductivity. As a result, when the cooling module abuts the heating body, the cooling rate increases and the entire back surface of the heating body is uniformly cooled so that the temperature distribution of the heating body during cooling is made more uniform.

The advantage described above cannot be obtained by improving one or the other of the flatness of the surface of the substrate of the heating body that comes into contact with the cooling module and the flatness of the surface of the cooling module that comes into contact with the substrate. The advantage described above can be obtained when the sum of the two flatnesses is no more than 0.8 mm.

In order to make the contact surfaces of the substrate and the cooling module flat, a method such as the well-known lapping/polishing method or polishing with a grindstone can be used. It would be preferable for the surface roughness of the processed surface to have an Ra of no more than 5 microns. By having the contact surfaces of the substrate and the cooling module formed with a surface roughness with an Ra of no more than 5 microns, the adhesion between the heater substrate and the cooling module is improved and the uniformity of the temperature distribution and the cooling rate of the heater substrate are improved.

In particular, by improving the surface roughness of the contact surface of the substrate so that it approaches a mirror surface, the emissivity of the surface is reduced. When the emissivity is reduced, the heat dissipation from that surface is reduced, making it preferable for conserving electrical power needed to heat the heating body. Also, if the substrate of the heating body is formed from ceramics, a rough surface can lead to more dropped ceramics particles due to friction from contact with the cooling module and the like. This leads to loose particles, which can negatively influence the quality of the heated object. Thus, it would be more preferable for the surface roughness to have an Ra of no more than 1 micron.

If a ceramic substrate is used that has a heater circuit and an insulation layer to protect the heater circuit formed on the back surface, too much processing of the surface that will come into contact with the cooling module in order to achieve flatness can result in a thin insulative layer and in certain cases can expose the heater circuit, leading to short-circuits. The thickness of the insulation layer can be increased in order to prevent this, but the insulation layer often has a low thermal conductivity so that increasing the thickness increases thermal resistance and reduces the cooling rate. Thus, it would be preferable for the thickness of the insulation layer after surface processing to be at least 15 microns and no more than 500 microns.

If there are variations in the thickness of the insulation layer after surface processing, there can be variations in the thermal resistance and the cooling rate, which tends to result in non-uniform temperature distribution for the substrate. Thus, it would be preferable for the thickness of the insulation layer after surface processing to be uniform. It would be preferable for the difference between the maximum value and the minimum value of the thickness of the insulation layer to be no more than 200 microns.

For example, a cooling module may be installed in a container with raising and lowering means, e.g., an air cylinder, so that the module can be placed into contact with or separated from the heating body as needed. A through-hole is formed on the cooling module in order to allow insertion of objects such as electrodes to supply power and temperature measuring means.

Also, it would be preferable for the heating body and the cooling module to be placed in a metal container. By doing so, influence on the temperature distribution on the heating surface of the heating body from air currents and the like is prevented, thus providing a more uniform temperature distribution. Also, it would be preferable to have the distance between the metal container and the heating body to be as fixed as possible. The reason for this is that if the heating body comes close to the container, the thermal transmission to the container increases relatively while the temperature of the heating surface decreases relatively.

By having a base heater equipped on the back side or wafer mounting surface side of the base, it is possible to correct temperature variations in the base itself Because the design is such that there is more heat generated toward the outer perimeter of the base heater, temperature variations due to heat escaping from the outer perimeter can be corrected. By applying nickel (Ni) or gold (Au) plating on the base surface, oxidation and thermal degradation of the base is prevented. If the material used is the base is not suitable for the wafer, the material used in the base is not exposed on the surface, thus preventing impurities from entering the substrate.

Since a heating device equipped with a heating body and cooling module described above provides uniform temperature distribution for the heating surface, it is suitable especially for semiconductor fabrication devices in which semiconductor wafers are heated. For example, it is possible to use the device for heaters used to cure resin films formed on wafers, heaters for inspecting semiconductors, film-forming devices, etching and ashing devices, and the like.

### First Embodiment

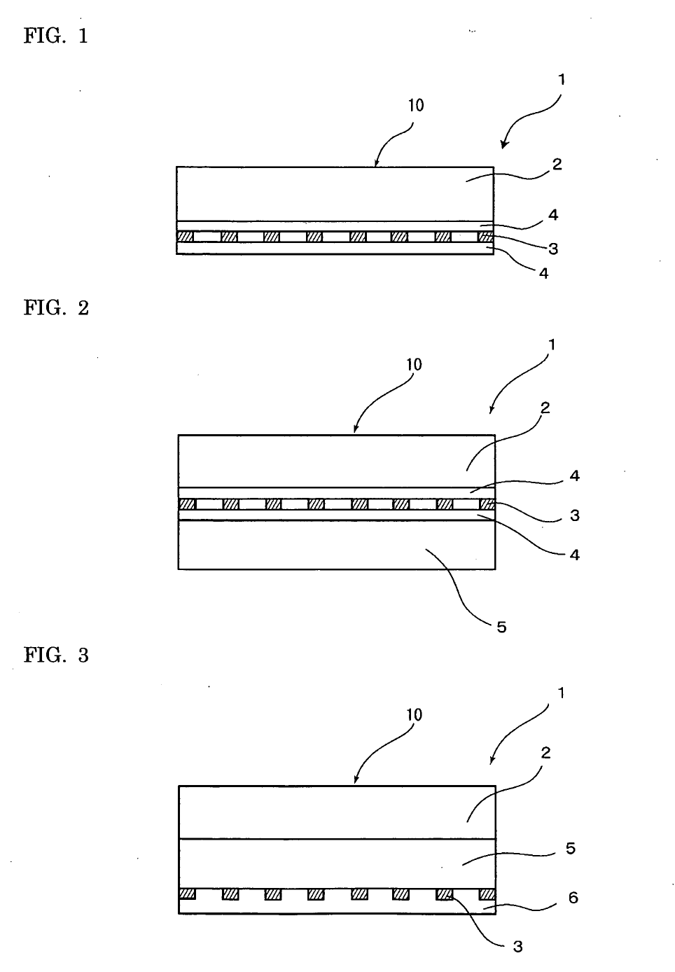

As shown in FIG. 1, a stainless steel resistance heating body 3 having a thickness of 50 microns and a diameter of 330 mm and in which a heater circuit is formed from a single zone is interposed between two polyimide plates (thickness 150 microns) serving as insulators 4. A copper plate 2 having a thickness of 15 mm and a diameter of 330 mm is attached, resulting in a heating body 1. The copper plate is nickel-plated.

This heating body was placed in a stainless steel container. The heating body was heated to 130 deg C. and a room-temperature (25 deg C.) wafer thermometer having a diameter of 300 mm was mounted on a heating surface 10. The temperature on the wafer thermometer was measured at 30 seconds after mounting, 60 seconds after mounting, and 5 minutes. The differences between the maximum measured temperature and the minimum measured temperature are shown in Table 1. The table also shows the heat capacity and the thermal conductivity of the copper plate used as the base.

TABLE 1

| | Thermal | | | |
|---|---|---|---|---|
| Heat capacity | conductivity | Temperature ranges (° C.) | | |
| (J/K · cm³) | (W/mK) | 30 sec | 60 sec | 5 minutes |
| 3.4 | 403 | 0.8 | 0.3 | 0.15 |

### Second Embodiment

As shown in FIG. 2, a stainless steel resistance heating body 3 having a thickness of 50 microns and a diameter of 330 mm was interposed between two polyimide plates 4 as in the first embodiment, and this was then placed between a base 5 and a base 2 having a diameter of 330 mm, resulting in a heating body 1. The thickness of the base 2 was 4.5 mm and the thickness of the base 5 was 10.5 mm. The materials used for the base 2 and the base 5 are as shown in Table 2. The copper plates were nickel-plated. These heating bodies were attached in a stainless steel container and, as in the first embodiment, a wafer thermometer was mounted on the heating surface and temperature ranges were measured after 30 seconds, 60 seconds, and 5 minutes. The results, along with the heat capacity and the thermal conductivity of the bases are shown in Table 2.

TABLE 2

| | | | | Temperature | | |
|---|---|---|---|---|---|---|
| | | Heat | Thermal | ranges (° C.) | | |
| | | capacity | conductivity | | 60 | |
| Base 2 | Base 5 | (J/Kcm³) | (W/mK) | 30 sec | sec | 5 min |
| Ni | Ni | 3.9 | 94 | 0.15 | 0.09 | 0.08 |
| Fe | Fe | 3.4 | 84 | 0.17 | 0.12 | 0.09 |
| Cu | Cu | 3.4 | 403 | 0.09 | 0.08 | 0.06 |
| Co | Co | 3.8 | 69 | 0.21 | 0.15 | 0.13 |
| Pd | Pd | 3.0 | 72 | 0.11 | 0.08 | 0.08 |
| Al | Al | 2.4 | 236 | 0.12 | 0.10 | 0.09 |
| Cu—Mo | Cu—Mo | 3.2 | 232 | 0.09 | 0.07 | 0.07 |
| Si | Si | 1.8 | 100 | 1.00 | 0.9 | 0.7 |

### Third Embodiment

A heating body was prepared and temperature ranges were measured with a wafer thermometer as in the second embodiment except that, as shown in Table 3, metal and ceramic composite bodies were used as the material for the base 2 and the base 5. The results are shown in Table 3. In the table, Si-70SiC, for example, indicates a composite material of Si and SiC with an SiC content of 70 percent by weight.

TABLE 3

| | | | Thermal | | | |
|---|---|---|---|---|---|---|
| | | Heat capacity | conductivity | Temperature ranges (° C.) | | |
| Base 2 | Base 5 | (J/Kcm³) | (W/mK) | 30 sec | 60 sec | 5 min |
| Si—70SiC | Si—70SiC | 3.0 | 172 | 0.13 | 0.10 | 0.07 |
| Al—30SiC | Al—30SiC | 2.3 | 150 | 0.17 | 0.13 | 0.10 |
| Al—AlN | Al—AlN | 2.8 | 176 | 0.13 | 0.10 | 0.07 |

### Fourth Embodiment

A mixture of 100 parts by weight of aluminum nitride powder and 0.5 parts by weight of yttrium oxide (Y₂O₃) powder was prepared. 10 parts by weight of polyvinyl butyral serving as a binder and 5 parts by weight of dibutyl phthalate serving as a solvent were mixed in and granules were formed by spray drying. The result was shaped with a press and degreased in a nitrogen atmosphere at 700 deg C. and sintered for 5 hours in a nitrogen atmosphere at 1850 deg C., to form an aluminum nitride sintered body. The aluminum nitride powder had an average particle diameter of 0.6 microns and a specific surface area of 3.4 m²/g. The aluminum nitride sintered body was processed to form a diameter of 330 mm and a thickness of 10.5 mm. The thermal conductivity of this aluminum nitride (AlN) sintered body was 175 W/mK.

Also, 100 parts by weight of silicon carbide (SiC) powder, 0.5 parts by weight of boron (B) powder, and 0.5 parts by weight of carbon (C) powder were mixed. Then, 10 parts by weight of polyvinyl butyral were added as a binder and 5 parts by weight of dibutyl phthalate were added as a solvent, and granules were formed by spray drying. The result was shaped with a press so that after sintering and abrading, a sintered body with a diameter of 330 mm and a thickness of 10.5 mm could be obtained. Degreasing was performed at 700 deg C. in an argon (Ar) atmosphere, sintering was performed for 5 hours in a nitrogen atmosphere at 2000 deg C., resulting in an SiC sintered body. This SiC sintered body was processed to form a diameter of 330 mm and a thickness of 10.5 mm. The thermal conductivity of the SiC sintered body was 195 W/mK.

Also, 100 parts by weight of aluminum oxide (Al₂O₃) powder and 2 parts by weight of magnesium oxide (MgO) powder were mixed. Then, 10 parts by weight of polyvinyl butyral serving as a binder and 5 parts by weight of dibutyl phthalate serving as a solvent were mixed, and granules were formed by spray drying. The result was shaped using a press so that after sintering and abrading a sintered body could be obtained with a diameter of 330 mm and a thickness of 10.5 mm. Degreasing was performed in an open-air atmosphere at 500 deg C. and sintering was performed in a nitrogen atmosphere for 5 hours at 1550 deg C., resulting in an Al₂O₃ sintered body. This Al₂O₃ sintered body was processed to form a diameter of 330 mm and a thickness of 10.5 mm. The thermal conductivity of this Al₂O₃ sintered body was 24 W/mK.

A W paste was prepared using 100 parts by weight of W powder having an average particle diameter of 2.5 microns, 1 part by weight of Y₂O₃, 5 parts by weight of ethyl cellulose serving as a binder, and butyl carbitol serving as a solvent. A pot mill and a triple roll mill were used for mixing. This W paste was screen-printed onto the AlN sintered body and SiC sintered body described above to form heating body circuit patterns. Then, degreasing was performed in a nitrogen atmosphere at 900 deg C. and firing was performed in a nitrogen atmosphere at 1800 deg C. for 1 hour.

Also, a W paste was prepared using 100 parts by weight of W powder having an average particle diameter of 2.0 microns, 1 part by weight of MgO, 5 parts by weight of ethyl cellulose serving as a binder, and butyl carbitol serving as a solvent. A pot mill and a triple roll mill were used for mixing. This W paste was screen-printed on one surface of the Al₂O₃ sintered body described above to form a heater circuit pattern. This was then degreased in an nitrogen atmosphere at 900 deg C. and fired for 1 hour in a nitrogen atmosphere at 1500 deg C.

As shown in FIG. 3, an insulative coating film 6 was formed on surfaces on which the heater circuit pattern 3 were formed on the AlN sintered body, the SiC sintered body, and Al₂O₃ sintered body by applying a thickness of 50 microns of a B₂O₃—Al₂O₃-based glass paste excluding the power supply section and a section for attaching a temperature measurement element. This was then fired in a nitrogen atmosphere at 700 deg C. The power supply section was formed as a ceramic base upon which a tungsten terminal, not shown in the figure, was screwed in.

The ceramic base and a copper plate having a diameter of 330 mm and a thickness of 4.5 mm were assembled to form a heating body 1. As in the first embodiment, a wafer thermometer was mounted on the heating body to measure temperature ranges. The results are shown in Table 4.

TABLE 4

| | | Temperature ranges | | |
|---|---|---|---|---|
| | | (° C.) | | |
| Base 2 | Base 5 | 30 sec | 60 sec | 5 min |
| Cu | AlN | 0.40 | 0.21 | 0.12 |
| Cu | SiC | 0.30 | 0.15 | 0.10 |
| Cu | Al₂O₃ | 0.80 | 0.60 | 0.54 |

### Fifth Embodiment

Using the same structure as in the second embodiment, the combinations shown in Table 5 were used for the thicknesses of the base 2 and the base 5 and the temperature ranges were measured in the same manner as in the second embodiment. The results are shown in Table 5. Table 5 also shows the ratio (a/(a+b)) of a thickness a of the base 2 and the thickness b of the base 5.

TABLE 5

| Base 2 | Base 5 | | Temperature ranges (° C.) | | |
|---|---|---|---|---|---|
| (mm) | (mm) | a/(a + b) | 30 sec | 60 sec | 5 min |
| 0.6 | 14.4 | 0.04 | 0.80 | 0.74 | 0.62 |
| 0.9 | 14.1 | 0.06 | 0.12 | 0.09 | 0.07 |
| 1.5 | 13.5 | 0.10 | 0.10 | 0.08 | 0.06 |
| 3.0 | 12.0 | 0.20 | 0.15 | 0.09 | 0.07 |
| 4.5 | 10.5 | 0.30 | 0.20 | 0.10 | 0.08 |
| 7.5 | 7.5 | 0.50 | 0.23 | 0.17 | 0.10 |
| 10.5 | 4.5 | 0.70 | 0.33 | 0.23 | 0.11 |
| 14.25 | 0.77 | 0.95 | 0.50 | 0.32 | 0.20 |
| 14.55 | 0.45 | 0.97 | 0.90 | 0.72 | 0.65 |

When the ratio (a/(a+b)) of the thickness a of the base with the heating surface and the thickness b of the base disposed on the back surface thereof is in the range of at least 0.05 and no more than 0.95, the resulting temperature range is small and superior temperature uniformity is provided.

### Sixth Embodiment

In the first embodiment through the fifth embodiment, the position of the temperature detector of the temperature sensor is 2 mm from the resistance heating body. Here, the temperature ranges were measured in the same manner as in the second embodiment using the same structures as in the second embodiment except that the positions were set as shown in Table 6 and the thicknesses of the base 2 and the base 5 were both set to 7.5 mm. Also, the temperature of the wafer thermometer increases as soon as the wafer thermometer is mounted on the heating surface, but the temperature drops to the normal temperature setting (130 deg C.) once the temperature reaches past the normal temperature setting. This temperature exceeding the setting temperature (the overshoot) is also measured. The results are shown in Table 6.

TABLE 6

| | | Detection | | | | |
|---|---|---|---|---|---|---|
| | | position | Overshoot | Temperature ranges (° C.) | | |
| Base 2 | Base 5 | (mm) | (° C.) | 30 sec | 60 sec | 5 min |
| Cu | Cu | 0 | 0 | 0.20 | 0.16 | 0.08 |
| Cu | Cu | 1 | 0 | 0.22 | 0.19 | 0.12 |
| Cu | Cu | 2 | 0.02 | 0.23 | 0.17 | 0.10 |
| Cu | Cu | 3 | 0.06 | 0.21 | 0.15 | 0.10 |
| Cu | Cu | 5 | 0.08 | 0.20 | 0.13 | 0.11 |
| Cu | Cu | 6 | 0.12 | 0.25 | 0.16 | 0.12 |

### Seventh Embodiment

Heating bodies were prepared in the same manner as in the second embodiment using the same structure as the heating body from the second embodiment with the base made from Cu and with the flatnesses of the upper and lower surfaces of the base 2 and the upper surface of the base 5 set as shown in Table 7. Temperature ranges were measured and the results are shown in Table 7.

TABLE 7

| | | | Temperature | | |
|---|---|---|---|---|---|
| Flatness (mm) | | | ranges (° C.) | | |
| Upper surface | Lower surface | Upper surface | | 60 | |
| base 2 | base 2 | base 5 | 30 sec | sec | 5 min |
| 0.02 | 0.04 | 0.04 | 0.17 | 0.09 | 0.07 |
| 0.04 | 0.04 | 0.04 | 0.20 | 0.10 | 0.08 |
| 0.06 | 0.04 | 0.04 | 0.28 | 0.21 | 0.16 |
| 0.09 | 0.04 | 0.04 | 0.39 | 0.30 | 0.22 |
| 0.10 | 0.04 | 0.04 | 0.51 | 0.44 | 0.31 |
| 0.12 | 0.04 | 0.04 | 0.84 | 0.63 | 0.41 |
| 0.04 | 0.02 | 0.04 | 0.16 | 0.09 | 0.08 |
| 0.04 | 0.04 | 0.04 | 0.20 | 0.10 | 0.08 |
| 0.04 | 0.06 | 0.04 | 0.29 | 0.18 | 0.12 |
| 0.04 | 0.09 | 0.04 | 0.41 | 0.33 | 0.20 |
| 0.04 | 0.10 | 0.04 | 0.56 | 0.44 | 0.32 |
| 0.04 | 0.12 | 0.04 | 0.87 | 0.65 | 0.45 |
| 0.04 | 0.04 | 0.02 | 0.15 | 0.09 | 0.08 |
| 0.04 | 0.04 | 0.04 | 0.20 | 0.10 | 0.08 |
| 0.04 | 0.04 | 0.06 | 0.30 | 0.20 | 0.15 |
| 0.04 | 0.04 | 0.09 | 0.45 | 0.34 | 0.21 |
| 0.04 | 0.04 | 0.10 | 0.50 | 0.46 | 0.32 |
| 0.04 | 0.04 | 0.12 | 0.80 | 0.64 | 0.44 |

### Eighth Embodiment

A stainless steel heating body with a thickness of 50 microns was prepared with the inner and outer wire widths changed so that the heat generation density c (W/cm²) of a region with a radius ½ that of the resistance heating body and the heating density d (W/cm²) outward therefrom have ratios (c/(c+d)) as shown in Table 8. Heating bodies similar to those of the second embodiment are prepared using copper plates with a thickness of 4.5 mm and 10.5 mm. Temperature ranges for these heating bodies were measured as in the first embodiment. The results are shown in Table 8.

TABLE 8

| Heat generation | Temperature ranges | | |
|---|---|---|---|
| density ratio | (° C.) | | |
| (c/(c + d)) | 30 sec | 60 sec | 5 min |
| 0.04 | 0.50 | 0.40 | 0.40 |
| 0.06 | 0.40 | 0.23 | 0.11 |
| 0.30 | 0.25 | 0.10 | 0.08 |
| 0.48 | 0.29 | 0.20 | 0.10 |
| 0.60 | 0.50 | 0.45 | 0.35 |
| 0.80 | 0.70 | 0.60 | 0.55 |

### Ninth Embodiment

Heating bodies were prepared as in the second embodiment except that the materials shown in Table 9 were used to cover the heating surface 10 of the Cu substrate 2 used in the second embodiment. Temperature ranges were measured as in the first embodiment and the results are shown in Table 9.

TABLE 9

| | Temperature ranges | | |
|---|---|---|---|
| | (° C.) | | |
| Surface covering | 30 sec | 60 sec | 5 min |
| Al₂O₃ thermal spraying | 0.09 | 0.08 | 0.07 |
| AlN vapor deposition | 0.10 | 0.08 | 0.07 |
| SiC vapor deposition | 0.08 | 0.07 | 0.06 |
| C spray | 0.06 | 0.05 | 0.03 |
| Polyimide tape | 0.07 | 0.06 | 0.05 |
| Silicon resin | 0.07 | 0.06 | 0.05 |

### Tenth Embodiment

Heating bodies having the same structure as the heating bodies with copper plate bases used in the second embodiment were prepared except that the materials used for the heating body were as shown in Table 10. Temperature ranges were measured as in the first embodiment. The results are shown in Table 10. The thicknesses of the heating bodies were 50 microns.

TABLE 10

| | Temperature ranges | | |
|---|---|---|---|
| Heat-generating | (° C.) | | |
| body material | 30 sec | 60 sec | 5 min |
| Stainless steel | 0.09 | 0.08 | 0.06 |
| (second embodiment) | | | |
| Ni—Cr | 0.10 | 0.09 | 0.07 |
| Mo | 0.09 | 0.08 | 0.06 |
| Ni | 0.08 | 0.07 | 0.06 |

### Eleventh Embodiment

Heating bodies were prepared as in the fourth embodiment with the AlN substrate used in the fourth embodiment except that instead of using W, the heating bodies were formed using the materials shown in Table 11. The temperature ranges were measured as in the first embodiment and the results are shown in Table 11.

TABLE 11

| | Temperature ranges | | |
|---|---|---|---|
| Heat-generating | (° C.) | | |
| body material | 30 sec | 60 sec | 5 min |
| W (fourth embodiment) | 0.40 | 0.21 | 0.12 |
| Ag—Pd | 0.40 | 0.21 | 0.12 |
| Pt | 0.40 | 0.21 | 0.12 |

According to the present invention, all or part of a base of a heating body is formed from a material with a heat capacity per unit volume of at least 2.0 J/K·cm³ and a thermal conductivity of at least 50 W/mK. This provides greater uniformity in the temperature distribution of the heating body especially during a transitional state. A uniform temperature distribution can also be achieved during a regular state. Compared to conventional devices, semiconductor fabrication/inspection devices, flat display panel fabrication/inspection devices, and photoresist heating devices equipped with this type of heating body can provide a more uniform temperature distribution for the heating body, thus making it possible to improve performance, yield, reliability, integration, and image quality in semiconductors and flat display panels.

1. A semiconductor fabrication device heater, comprising:
a base formed with a heating surface for heating an object to be processed by mounting said object or by heating from a fixed distance; and a resistance heating body, wherein all or part of said base of said heater is formed from a material with a heat capacity per unit volume of at least 2.0 J/K·cm³ and a thermal conductivity of at least 50 W/mK.

2. A semiconductor fabrication device heater according to claim 1 wherein said base formed with the heating surface for heating an object to be processed by mounting said object or by heating from a fixed distance is formed from a metal or an alloy or a composite body of metal and ceramics, on the back surface thereof being attached a metal or alloy film serving as a resistance heating body.

3. A semiconductor fabrication device heater according to claim 1 comprising:
a second base disposed on a back surface of said base.

4. A semiconductor fabrication device heater according to claim 3 wherein:
said base formed with the heating surface for heating an object to be processed by mounting said object or by heating from a fixed distance is formed from a metal or an alloy or a composite body of metal and ceramics;
said second base disposed on a back surface of said base is formed from a metal or an alloy or a composite body of metal and ceramics; and
a metal or alloy foil is interposed between said bases to serve as a resistance heating body.

5. A semiconductor fabrication device heater according to claim 3 wherein:
said base formed with the heating surface for heating an object to be processed by mounting said object or by heating from a fixed distance is formed from a metal or an alloy or a composite body of metal and ceramics;
said second base disposed on a back surface of said base is formed from ceramics; and
a metal or alloy foil is interposed between said bases to serve as a resistance heating body.

6. A semiconductor fabrication device heater according to claim 3 wherein:
said base formed with the heating surface for heating an object to be processed by mounting said object or by heating from a fixed distance is formed from a metal or an alloy or a composite body of metal and ceramics;
said second base disposed on a back surface of said base is formed from ceramics; and
a circuit serving as a resistance heating body is formed on said ceramics.

7. A semiconductor fabrication device heater according to claim 3 wherein:
a ratio (a/(a+b)) of a thickness a of said base formed with the heating surface for heating an object to be processed by mounting said object or by heating from a fixed distance and a thickness b of said second base disposed on a back surface of said base is at least 0.05 and no more than 0.95.

8. A semiconductor fabrication device heater according to claim 1 wherein a temperature detector of a temperature sensor for detecting a temperature of said base formed with the heating surface for heating an object to be processed by mounting said object or by heating from a fixed distance is disposed between said heating surface and said resistance heating body and is positioned no more than 5 mm from said resistance heating body.

9. A semiconductor fabrication device heater according to claim 1 wherein an emissivity of said heating surface of said base formed with the heating surface for heating an object to be processed by mounting said object or by heating from a fixed distance is at least 0.5.

10. A semiconductor fabrication device heater according to claim 9 wherein an emissivity of said heating surface of said base formed with the heating surface for heating an object to be processed by mounting said object or by heating from a fixed distance is at least 0.8.

11. A semiconductor fabrication device heater according to claim 1 wherein a flatness of said heating surface of said base formed with the heating surface for heating an object to be processed by mounting said object or by heating from a fixed distance is no more than 0.1 mm.

12. A semiconductor fabrication device heater according to claim 11 wherein a flatness of said heating surface of said base formed with the heating surface for heating an object to be processed by mounting said object or by heating from a fixed distance is no more than 0.05 mm.

13. A semiconductor fabrication device heater according to claim 1 wherein a flatness of said back surface of said heating surface of said base formed with a the heating surface for heating an object to be processed by mounting said object or by heating from a fixed distance is no more than 0.1 mm.

14. A semiconductor fabrication device heater according to claim 3 wherein a flatness of said second base disposed on said back surface is no more than 0.1 mm.

15. A semiconductor fabrication device heater according to claim 1 wherein a ratio (c/(c+d)) between a heat generation density c (W/cm²) of a region with a radius ½ that of said heater from a center of said heater and a heat generation density d (W/cm²) of a region outward therefrom is at least 0.05 and no more than 0.49.

16. A semiconductor fabrication device heater according to claim 2 wherein said metal or alloy is at least one metal or alloy selected from a list consisting of copper (Cu), nickel (Ni), iron (Fe), cobalt (Co), palladium (Pd), and aluminum (Al).

17. A semiconductor fabrication device heater according to claim 2 wherein said composite body of metal and ceramics is at least one composite body selected from a list consisting of a composite body of silicon and silicon carbide, a composite body of aluminum and silicon carbide, and a composite body of aluminum and aluminum nitride.

18. A semiconductor fabrication device heater according to claim 5 wherein said ceramics is at least one type of ceramics selected from a list consisting of aluminum nitride (AlN), silicon carbide (SiC), and aluminum oxide (Al₂O₃).

19. A semiconductor fabrication device heater according to claim 1 wherein a material with a high emissivity covers said heating surface.

20. A semiconductor fabrication device heater according to claim 19 wherein said cover material is a ceramics.

21. A semiconductor fabrication device heater according to claim 20 wherein said ceramics is at least one type of ceramics selected from a list consisting of aluminum oxide (Al₂O₃), aluminum nitride (AlN), silicon carbide (SiC), and carbon (C).

22. A semiconductor fabrication device heater according to claim 19 wherein said cover material is heat-resistant resin.

23. A semiconductor fabrication device heater according to claim 22 wherein said heat-resistant resin is polyimide, fluoroplastic, silicon resin, or epoxy resin.

24. A semiconductor fabrication device heater according to claim 1 wherein a component of said resistance heating body is at least one selected from a list consisting of tungsten (W), molybdenum (Mo), nickel (Ni), chrome (Cr), silver (Ag), palladium (Pd), platinum (Pt), and stainless steel (SUS).

25. A semiconductor fabrication device equipped with a semiconductor fabrication device heater according to claim 1.
